(19) United States
(12) Patent Application Publication
(10) Pub. No.: US 2002/0050051 A1
(43) Pub. Date: May 2, 2002

(54) Method for making aromatic metal with various colors

(75) Inventor: Byung-Tai Choi, Inchon-si (KR)

Correspondence Address: Richard S. Milner, Cooper & Dunham LLP, 1185 Avenue of the Americas, New York, NY, 10036, US

(73) Assignee: S.M. Aroma Co. Ltd.,, Inchon-si (KR)

(21) Appl. No.: 09/853,203

(22) Filed: May 11, 2001

(30) Foreign Application Priority Data
Oct. 27, 2000 (JP) 2000-328770

(51) Int. Cl. C23F 1/00; B44C 1/22

(52) U.S. Cl. 29/527.1; 29/557; 216/58

(57) ABSTRACT

Disclosed is a method for making aromatic metal products which have splendid appearance with various colors and emit fragrance. Suitable for use in fancy goods, the aromatic metal products are prepared by sintering a pre-molded body between 900 and 1,400° C. to give a porous metallic sintered body with a porosity of 10-20%; cleansing the porous metallic sintered body to remove impurities therefrom; etching the cleansed sintered body in a vacuum furnace and plating it with Ti by sputtering; and introducing fragrance into the Ti-plated sintered body. The pre-molded body is made by pressuring a mixture containing a metal powder with a mean particle size of 100 μm or greater and a binder at room temperature under a pressure of 100-600 MPa. The introduction of a perfume can be achieved in a forcible manner in which the sintered body is charged in a vacuum bath to remove inner air therefrom, followed by the infiltration of the perfume. Alternatively, the sintered body may be simply immersed in a perfume liquid to naturally infiltrate the perfume thereinto. The porous metal may be based on a material such as stainless steel, nickel, copper-zinc, gold or silver.

### BACKGROUND OF THE INVENTION

1. Field of the Invention

The present invention relates, in general, to a method for making aromatic metal of various colors and, more particularly, to a method for making metallic materials.

2. Description of the Prior Art

In recent times, a lot of fancy goods, including accessories, watches, writing materials, etc., have been put on the market. On the whole, they are made of two types of materials: metal such as stainless steel, nickel, copper, etc.; and plastics.

Conventionally, the most essential aspect in the production of fancy goods such as accessories, watches, writing materials, etc., is that it has a pleasing appearance to consumers' eyes. To induce consumers to buy, most fancy goods are designed to have splendid and precise appearance.

However, appearance alone has been insufficient to hold consumers' attentions. In recent years, to capture the public fancy, which changes every moment, fragrance started to be adopted as an important allurement in plastic products, in addition to appearance.

Aromatic products made of plastics are, however, limited in applications. Limitation is also made in the odors that plastic products can emit.

Since metallic fancy products are usually manufactured and processed at high temperatures, it has been believed to be impossible to provide aromas to metallic fancy products to excite the olfactory senses of consumers.

Oilless bearings are made of porous materials that have pores therein at a porosity of about 10-20%. For use in the structures to which oil is impossible to supply, such as machine and automobile parts, the porous materials made by powder metallurgy have oil forcibly introduced into the pores.

### SUMMARY OF THE INVENTION

Leading to the present invention, the experiments based on the idea that porous metallic materials, such as materials for oilless bearings, could be used as materials for fancy goods, conducted by the present inventors, resulted in the finding that the porous metallic materials, when used for fancy goods, can provide a greater variety of fragrances to the olfactory senses of consumers, as well as affording more splendid appearances and higher durability than conventional aromatic plastics.

Therefore, it is an object of the present invention to overcome the above problems encountered in prior arts and to provide a method for making aromatic metal products with splendid appearance and high durability.

Based on the present invention, the above object could be accomplished by a provision of a method for making aromatic metal products, comprising the steps of: sintering a pre-molded body between 900 and 1,400° C. to give a porous metallic sintered body with a porosity of 10-20%, said pre-molded body being made by compressing a mixture containing a metal powder with a mean particle size of 100 μm or greater and a binder at room temperature under 100-600 MPa; cleansing the porous metallic sintered body to remove impurities therefrom; etching the cleansed sintered body in a vacuum furnace and plating it with Ti by sputtering; and introducing fragrance into the Ti-plated sintered body. In embodiments of the present invention, the Ti-plating is carried out in various combinations of argon, N₂, C₂H₂, O₂ and CO₂ gases to form various colors. The porous metal employs as a matrix a metal material selected from stainless steel, nickel, copper-zinc, gold and silver.

### BRIEF DESCRIPTION OF THE DRAWING

FIG. 1 is a cross-sectional view showing a microstructure of the aromatic metallic material of the present invention.

### DETAILED DESCRIPTION OF THE INVENTION

The present invention pertains to the manufacture of porous metallic products suitable for use in fancy goods, which are highly durable, emit fragrances and have splendid appearances. In the present invention, the porous metallic products are made of stainless steel, copper, nickel or alloys thereof. These metals are advantageous in that they are not expensive and are so biocompatible as to cause no side effects upon contact with the skin. Additionally, titanium (Ti), gold and silver may be used as materials for the porous metallic products. Ti, although being expensive, is very attractive as a material for fancy goods because of its being easily colored. As for gold and silver, they are traditionally used as materials for ornaments because of their chemical stability. For the above-mentioned reasons, stainless steel, copper, nickel, titanium, gold, and silver can be used as materials for the porous metallic products of the present invention. Useful stainless steel is exemplified by SUS316. Cu-Zn is a kind of copper available in the present invention. Nickel, titanium, gold and silver each may be used alone or as a component in alloy.

Based on iron, stainless steel typically comprises C 0.030% by weight or less, Si 1.0% by weight or less, Mn 2.0% by weight or less, P 0.030% by weight, Ni 12-15% by weight or less, Cr 16-18% by weight or less, and Mo 2-3% by weight. Generally, Cu-Zn alloy comprises Zn at an amount of 40% by weight or less.

Metal is used in a powder form with a mean particle size of 100 μm or larger. Large particles are used because they produce such large voids therebetween that liquid fragrance can easily penetrate into the sintered body prepared from the particles.

To manufacture porous metallic products, first, the selected metal particles with various diameters are mixed with a binder with the aid of, for example, a double cone-type mixer.

Subsequently, a pressing process is conducted at room temperature. In this regard, the material mixture is installed in a cold mold of a desired shape and pressed at 100-600 MPa in a twin-axis manner to give a pre-molded body with a porosity of, for example, 45%.

Afterwards, at a temperature higher than 900° C. but not higher than 1,400° C., the pre-molded body is sintered in a gas mixture of nitrogen and methane, in a reductive atmosphere containing nitrogen and hydrogen, or in a crack ammonia or vacuum atmosphere, to produce a porous metallic sintered body with a porosity of 10-20%.

In most cases, the porous metallic sintered body has impurities, such as fractions, attached thereon. These impurities are removed using T.C.E. ultrasonication or alkaline ultrasonication. Then, the sintered body is washed in an acid bath to completely remove alkaline materials which might remain even after the ultrasonication, followed by an acid-washing process. The sintered body is then thermally treated twice or more times at 40° C. for 10 min or longer to eliminate moisture therefrom. After completion of the dehydration, water blots might be formed on the sintered body. For the elimination of the water blots, the sintered body is subjected to ultrasonication and dried at 90° C. in a steam bath.

The reason why such a complex pre-treatment process is conducted is that, because the sintered body is porous, impurities adsorbed into the pores must be completely removed.

Next, the impurity-free sintered body is coated with Ti in a vacuum coating apparatus. To this end, etching is carried out to make the sintered body clean, followed by conducting a sputtering process by use of Ti.

At this time, various colors can be achieved on the surface of the sintered by appropriately controlling the sputtering conditions, including gas composition, sputtering time, electromagnetic field intensity, power, etc.

For example, a gold color appears in a gas mixture of argon and nitrogen by controlling the applied voltage and electromagnetic intensity. In addition, black colors are formed on the sintered body in an atmosphere of argon and acetylene (C₂H₂), brown colors in an atmosphere of argon, oxygen and nitrogen, blue colors in an atmosphere of argon and oxygen, and red colors in an atmosphere of argon and CO₂.

Thereafter, the Ti-plated porous, sintered body undergoes forcible perfume infiltration. Different processes for infiltrating perfumes into the sintered body may be used depending on porosities of the sintered body. All perfumes can be used.

Where the sintered body has a porosity of 10-15%, it is charged within a closed chamber which is then vacuumed to a pressure of 5×10⁻³ torr with the aid of a rotary pump and a diffusion pump to almost completely remove the air present within the sintered body. Next, the valves connected to the pumps are closed, after which a valve to the side of a perfume container is opened to allow the perfume to flow into the chamber, thereby infiltrating the perfume into pores of the sintered body by the force of restitution.

Further application of an air pressure of 50-100 MPa permits the perfume to penetrate into the voids which might remain unsoaked.

It is preferred that the forcible infiltration of a perfume is carried out at 5×10⁻² torr. The vacuum chamber in which the sintered body is present is maintained at this vacuum for 30 min, after which perfume infiltration is conducted for 10 min under vacuum. Afterwards, the perfume is further infiltrated into the sintered body forcibly at the same pressure for 5 min.

Alternatively, when the porous sintered metallic body has a porosity of as high as 15-20%, the immersion of the sintered body in a perfume liquid is sufficient to infiltrate the perfume into the sintered body through natural capillary action.

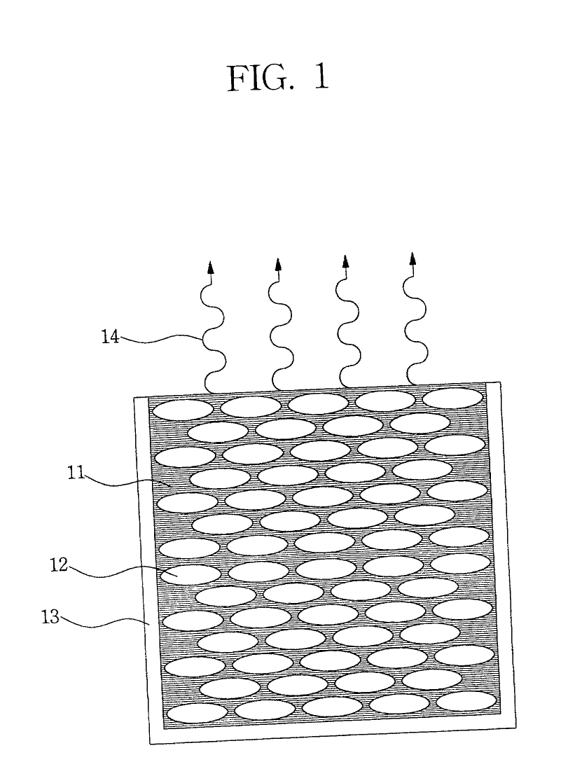

With reference to FIG. 1, there is shown an aromatic porous metal structure made by the present invention. As shown in this figure, pores 11 existing between metal particles 12 are filled with a perfume. Also, the sintered body is provided with a fragrance barrier to emit the fragrance in a selected direction.

A better understanding of the present invention may be obtained in light of the following examples which are set forth to illustrate, but are not to be construed to limit the present invention.

### EXAMPLE 1

Using stainless steel as a matrix metal, a porous, aromatic product was produced. The stainless steel comprised C 0.030% by weight or less, Si 2.0% by weight or less, Mn 2.0% by weight or less, P 0.045% by weight or less, S 0.030% by weight or less, Ni 12-15% by weight, Cr 16-18% by weight, and Mo 2-3% by weight. Stainless steel powders with a mean particle size of approximately 110 μm were mixed with a binder using a double cone-type mixer and pressed into a pre-molded body at 400 MPa.

Subsequently, the pre-molded body was sintered at 1,120-1,315° C. for 60-120 min in a nitrogen gas, crack ammonia or vacuum atmosphere to give a metallic material with a porosity of 5-15%. This porous metallic material was found to have a tensile strength of 300 MPa or higher and an elongation of 15% or higher. After being charged in an unbalanced magnetron sputtering (UBM) apparatus filled with a gas mixture of Ar and N₂, the sintered body was coated with Ti at a power of 2.5 kW with a bias voltage of 80 V under an electromagnetic field of 4 A to form a golden Ti coating layer of gold color. Thereafter, a perfume was forced to infiltrate into the porous material thus obtained in a vacuum bath. The final metallic material was porous and fragrant.

### EXAMPLE 2

Using nickel as a matrix, a porous, aromatic product was produced. Nickel powders with a mean particle size of approximately 110 μm were mixed with a binder in a double cone-type mixer and pressed into a premolded body at 300-600 MPa. Afterwards, the pre-molded body was sintered at a temperature between 900° C. and 1,050° C. for about 20 min to in an atmosphere of nitrogen and hydrogen to afford a porous metallic material. This porous material was measured to show a tensile strength of 150 MPa and an elongation of 10% or greater. After being charged in a UBM apparatus filled with a gas mixture of Ar and C₂H₂, the sintered body was coated with Ti at a power of 2.5 kW with a bias voltage of 80 V under an electromagnetic field of 4 A to form a blackish Ti coating layer. Thereafter, a perfume was infiltrated into the coated, sintered body in a forcible manner in a vacuum bath. Alternatively, the sintered body was allowed to stand in a perfume liquid. The final metallic material was porous and fragrant.

### EXAMPLE 3

Using a double cone-type mixer, stainless steel powders with a mean particle size of approximately 110 μm were mixed, followed by pressing the mixture into a pre-molded body at 400 MPa. Subsequently, the pre-molded body was sintered at 1,245° C. for 60-120 min in a vacuum atmosphere to give a porous metallic material. This porous metallic material was found to have a tensile strength of 350 MPa or higher and an elongation of 13% or higher. After being charged in a UBM apparatus filled with a gas mixture of O₂ and N₂, the sintered body was coated with Ti at a power of 2.5 kW with a bias voltage of 40 V under an electromagnetic field of 4 A to form a brownish Ti coating layer of gold color. Thereafter, a perfume was infiltrated into the porous material in a forcible manner in a vacuum bath. Alternatively, the sintered body was immersed in a perfume liquid to naturally infiltrate the perfume thereinto. The final metallic material was porous and fragrant.

### EXAMPLE 4

Using an alloy of copper and 40 wt % or less of zinc as a matrix, a porous, aromatic product was produced. Cu-Zn alloy powders with a mean particle size of approximately 110 μm were mixed with a binder in a double cone-type mixer and pressed into a premolded body at 300-600 MPa. Afterwards, the pre-molded body was sintered at a temperature between 900° C. and 925° C. for about 30 min in an atmosphere of crack ammonia to afford a porous metallic material. Depending on the content of zinc, physical properties of the porous material were measured to be at least 200 MPa in tensile strength and 13% or greater in elongation. After being charged in a UBM apparatus filled with a gas mixture of Ar and O₂, the sintered body was coated with Ti at a power of 2.5 kW with a bias voltage of 60 V under an electromagnetic field of 4 A to form a bluish Ti coating layer. Thereafter, a perfume was infiltrated into the coated, sintered body in a forcible manner in a vacuum bath. Alternatively, the sintered body was immersed in a perfume liquid to naturally infiltrate the perfume thereinto. The final metallic material was porous and fragrant.

### EXAMPLE 5

Using gold (Au) or silver (Ag) as a matrix, a porous, aromatic product was produced. Gold or silver powders with a mean particle size of approximately 70 μm were pressed into a premolded body at 100-300 MPa. Afterwards, for gold, the pre-molded body was sintered at 925-985° C. for about 30 min in a vacuum atmosphere. The resulting sintered body was found to have a tensile strength of 80 MPa or greater and an elongation of 20% or higher. In the case of silver, the sintering temperature was set between 900° C. and 920° C. At this temperature range, the sintering was carried out for 20 min. The durability of the silver sintered body was measured to be similar to that of the gold sintered body. After being charged in a UBM apparatus filled with a gas mixture of Ar and CO₂, the sintered body was coated with Ti at a power of 2.5 kW with a bias voltage of 60 V under an electromagnetic field of 4 A to form a reddish Ti coating layer. Thereafter, a perfume was infiltrated into the coated, sintered body in a forcible manner in a vacuum bath. Alternatively, the sintered body was immersed in a perfume liquid to naturally infiltrate the perfume thereinto. The final metallic material was porous and fragrant.

As described hereinbefore, metallic materials with a porosity of 10-20% can be filled with a perfume in a forcible manner or through capillary action. Emitting fragrance for a prolonged period of time in addition to showing splendid appearance, the porous metallic materials are very useful as materials for fancy goods, including accessories, writing materials, and the like.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A method for making aromatic metal products, comprising the steps of:
sintering a pre-molded body between 900 and 1,400° C. to give a porous metallic sintered body with a porosity of 10-20%, said pre-molded body being made by pressuring a mixture containing a metal powder with a mean particle size of 100 μm or greater and a binder at room temperature under 100-600 MPa;
cleansing the porous metallic sintered body to remove impurities therefrom;
etching the cleansed sintered body in a vacuum furnace and plating it with Ti by sputtering; and
introducing fragrance into the Ti-plated sintered body.

2. The method as set forth in claim 1, wherein the Ti plating step is carried out in an atmosphere of Ar plus N₂ to form a golden coating layer.

3. The method as set forth in claim 1, wherein the Ti plating step is carried out in an atmosphere of Ar plus C₂H₂ to form a blackish coating layer.

4. The method as set forth in claim 1, wherein the Ti plating step is carried out in an atmosphere of Ar, O₂ and N2 gas to form a brownish coating layer.

5. The method as set forth in claim 1, wherein the Ti plating step is carried out in an atmosphere of Ar and O₂ gas to form a bluish coating layer.

6. The method as set forth in claim 1, wherein the Ti plating step is carried out in an atmosphere of Ar and CO₂ gas to form a reddish coating layer.
